(19) United States
(12) Patent Application Publication
(10) Pub. No.: US 2007/0279843 A1
(43) Pub. Date: Dec. 6, 2007

(54) Transducer with improved fuse base structure

(76) Inventors: Yueh-Hua Hsu Huang, Chung-Ho City (TW); Lien-Huang Yang, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/445,176

(22) Filed: Jun. 2, 2006

(51) Int. Cl. H02B 1/26

(52) U.S. Cl. 361/626

(57) ABSTRACT

A transducer is provided with at least one fuse base along with a fuse built in either side of the transducer, and an upper cover is provided for protecting component parts contained in the transducer, and an opening with a protective cap is provided on the upper cover at the position facing to each corresponding fuse for keeping out infringement of foreign materials and detachable for replacement of the fuse. With this structure, upon replacement of the faulted fuse, it is not necessary to turn upside down for detaching the base cover to replace the fuse as that is done in a traditionally constructed transducer.

### BACKGROUND OF THE INVENTION

1. Field of the invention

The present invention relates to a transducer with improved fuse base structure, and more particularly, to a transducer provided with at least one fuse base equipped with a fuse, wherein the fuse can be easily replaced by taking off a protective cap covering on it.

2. Description of the Prior Art

As shown in FIG. 1, when replacing a broken fuse of a conventional transducer, the transducer 1 is turned upside down to detach a base cover 2 for replacing a new fuse 11, and then recovering the transducer 1 to its normal position after the new fuse 11 is installed in place and the base cover 2 is attached back to the transducer 1.

It is somewhat tedious and troublesome to replace a fuse by turning upside down and detaching the base cover even for a small transducer, not to speak of a bulky one.

For rectifying such an inconvenience inherent to the traditional transducer, the inventor of the present invention has plunged into this matter for years, and at last, come up with the present invention.

### SUMMARY OF THE INVENTION

The main object of the present invention is to provide a transducer with side built fuse bases with individually provided protective cap for each fuse so as to facilitate replacement of the fuse by only opening the corresponding protective cap.

To achieve the above object, the transducer with an improved fuse base structure according to the present invention comprises a transducer, at lest one fuse and fuse base with an individual protective cap, and an upper cover of the transducer. The fuse bases along with their fuses are built in one side of the transducer. The upper cover is for protecting the component parts of the transducer contained therein. An opening with a protective cap is provided on the upper cover at the position facing to each corresponding fuse so as to keep out infringement of foreign materials. Upon replacement of a faulted fuse, it is only required to detach the corresponding protective cap and replace with a new fuse without turning upside down to detach the base cover of the transducer as that is necessary for a conventional transducer so that the maintenance for the transducer of the present invention is very easy.

### BRIEF DESCRIPTION OF THE DRAWINGS

These features and advantages of the present invention will be fully understood and appreciated from the following detailed description in conjunction with the accompanying drawings in which:

FIG. 1 is a perspective view of a conventional transducer wherein a fractionary portion of the inside structure is shown;

FIG. 2 is an exploded three dimensional view of the transducer with improved fuse base structure of the present invention;

FIG. 3 is a perspective view of the present invention wherein one of the protective caps is detached; and

FIG. 4 is another perspective view of the present invention wherein all the protective caps are put on.

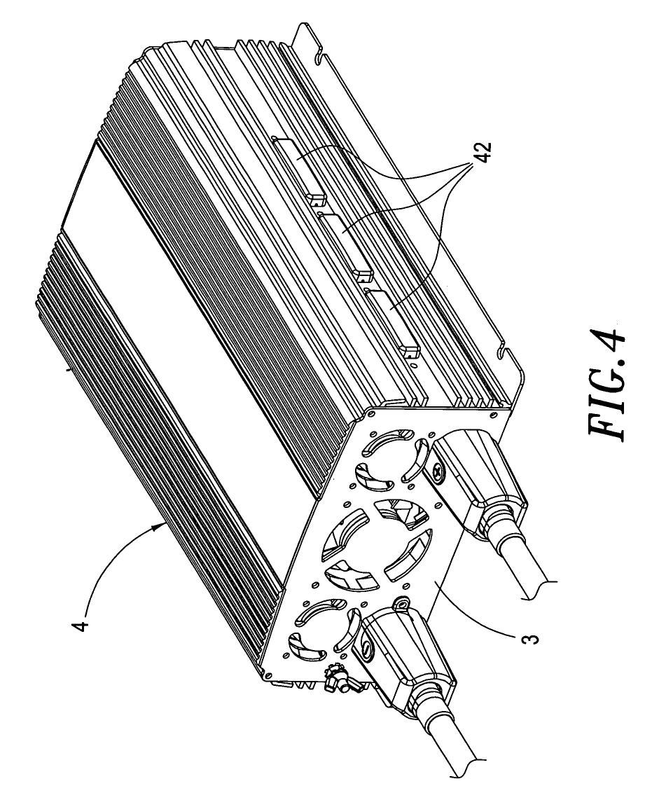

### DETAILED DESCRIPTION OF THE PREFERRED EMBODIMENT

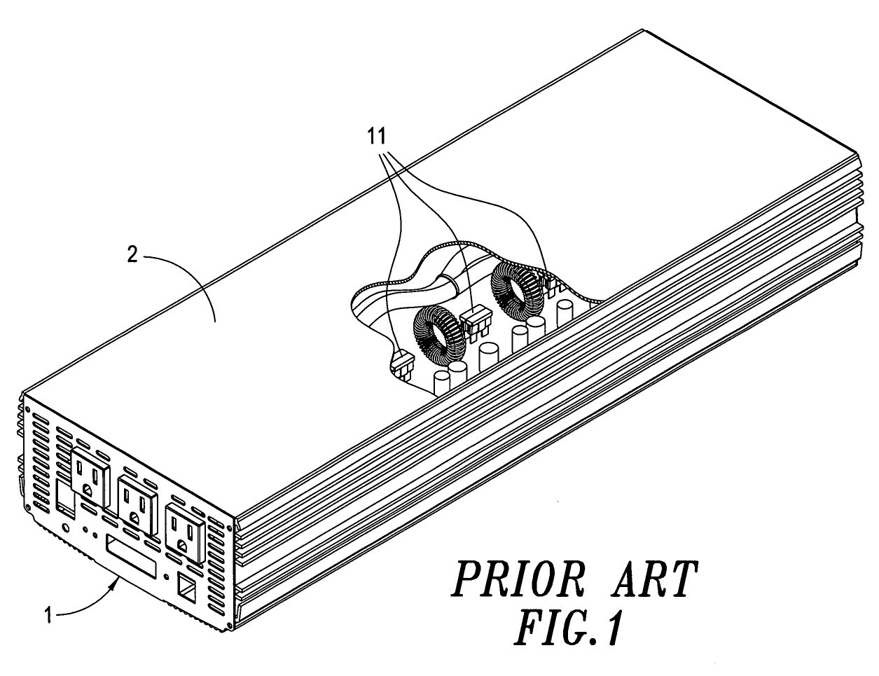

The structure of a conventional transducer shown in FIG. 1 and the defects thereof are known to one skilled in the arts and do not have to be repeated herein.

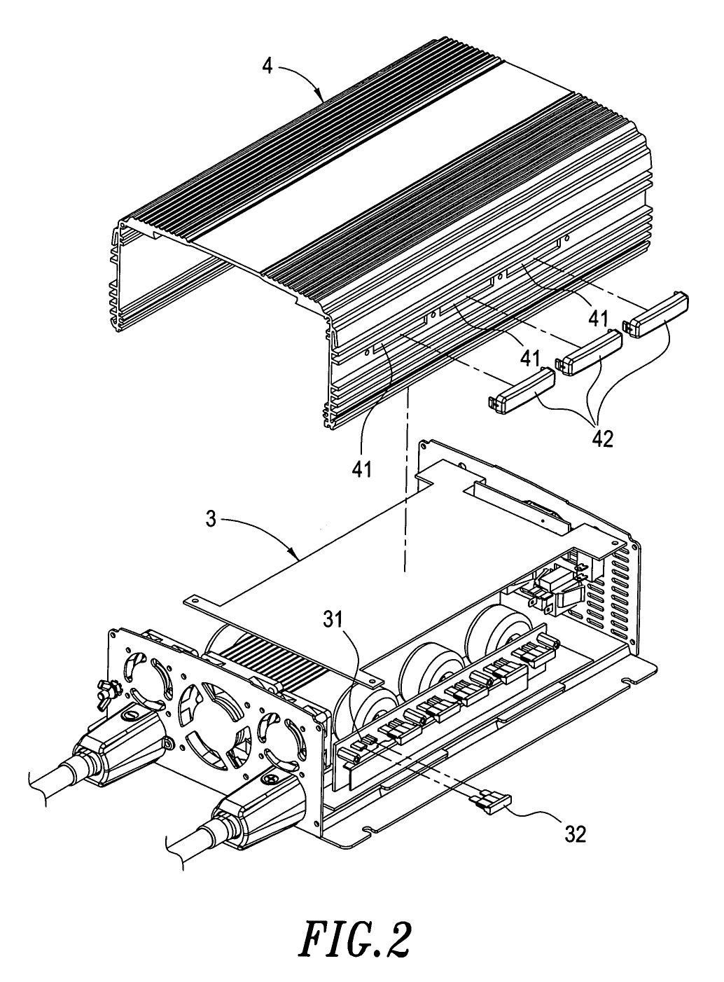

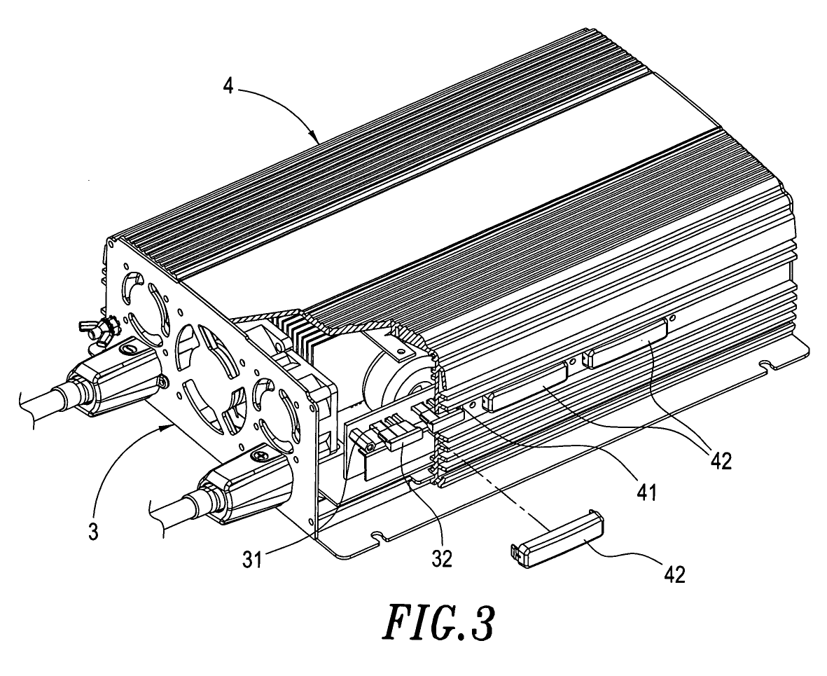

Referring to FIG. 2 and FIG. 3, the transducer with improved fuse base structure of the present invention comprises:

A transducer 3 with at least one fuse 32 and fuse base 31 built in one side of the transducer 3, wherein the fuse 32 and the fuse base 31 may be built in the other side of the transducer 3.

An upper cover 4 for protecting the component parts of the transducer 3 is contained therein. An opening 41 with a protective cap 42 is provided on the upper cover 4 at the position facing to each corresponding fuse 32 so as to keep out infringement of foreign materials. Being covered on the transducer 3, the upper cover 4 is capable of securely protecting the component parts contained in the transducer 3.

Upon replacement of faulted fuse 32, it is only necessary to detach the protective cap 42 corresponding to that particular fuse 32 and replace with a new fuse 32 without turning upside down to detach the base cover of the transducer 3 as that is a necessary procedure for a conventional transducer so as to simplify the maintenance work for the transducer.

It emerges from the above description that the transducer of the present invention has several distinct advantages compared with the conventional one, namely:

1. The fuse base along with the fuses is built in the side of the transducer, and each fuse has its own protective cap, upon replacement of a faulted fuse, only the protective cap corresponding to the faulted fuse is detached without the need of taking off the entire cover.

2. The present invention provides a simply constructed, easily operable and low cost transducer with improved fuse base structure.

3. The fuse base structure constructed as such is suitable for transducer of various types and sides.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A transducer with improved fuse base structure comprising:
a transducer;
at least one fuse base with a fuse built in one side of said transducer; and;
an upper cover for sealing said transducer to protect component parts contained in said transducer;
wherein an opening with a protective cap is provided on the upper cover at the position facing to each corresponding fuse for keeping out foreign materials and detachable for replacement of said fuse.

2. The transducer of claim 1, wherein said fuse base is built in either side of said transducer.
